(19) United States
(12) Patent Application Publication
(10) Pub. No.: US 2026/0284676 A1
(43) Pub. Date: Sep. 24, 2026

(54) JIG FOR CAP REPLACEMENT

(71) Applicant: FUJIFILM Corporation, Tokyo (JP)

(72) Inventors: Junichi KORI, Kanagawa (JP); Masayuki KUSUMOTO, Kanagawa (JP); Shinichi NAGAYAMA, Kanagawa (JP); Nozomu TONOIKE, Kanagawa (JP)

(73) Assignee: FUJIFILM Corporation, Tokyo (JP)

(21) Appl. No.: 19/563,352

(22) Filed: Mar. 11, 2026

Related U.S. Application Data
(63) Continuation of application No. PCT/JP2024/033101, filed on Sep. 17, 2024.

(30) Foreign Application Priority Data
Sep. 19, 2023 (JP) 2023-151413

(51) Int. Cl. B04B 15/00; B04B 7/02; B04B 7/06; B04B 11/02

(52) U.S. Cl. CPC B04B 15/00; B04B 7/06; B04B 11/02; B04B 2007/025

(57) ABSTRACT

A jig for cap replacement that is used in a centrifuge that centrifugally separates a sample by rotating a zonal rotor that accommodates a solution containing the sample and a density gradient medium, the jig for cap replacement being configured to replace a cap attachable to and detachable from an attachment port of the zonal rotor during rotation of the zonal rotor, the jig for cap replacement including an attachment/detachment arm including a holding part configured to hold the cap, and an arm moving mechanism that moves the attachment/detachment arm between an attachment/detachment position at which the cap is attached and detached and a retreat position at which the attachment/detachment arm retreats from the attachment/detachment position.

### CROSS-REFERENCE TO RELATED APPLICATIONS

This application is a continuation of International Application No. PCT/JP2024/33101, filed on Sep. 17, 2024, which claims priority from Japanese Patent Application No. 2023-151413, filed on Sep. 19, 2023. The entire disclosure of each of the above applications is incorporated herein by reference.

### BACKGROUND

### 1. Technical Field

The present disclosure relates to a jig for cap replacement.

### 2. Related Art

As a method of introducing a gene into mammalian cells for the purpose of gene therapy, a method using a virus vector is currently mainstream. As a virus that is a source of the virus vector, an enveloped virus such as a retrovirus, a lentivirus, a herpesvirus, or a Sendai virus, or a non-enveloped virus (that is, a virus having no envelope) such as an adenovirus or an adeno-associated virus (AAV) is known. Among these, AAV is used for gene therapy for the treatment of various diseases because it can infect many types of cells, has no pathogenicity to humans, and the virus particles are physically stable.

Since the AAV vector can efficiently introduce a gene for stably expressing a target gene in cells, it is useful as a means of gene delivery to target cells. In addition, in the production of the AAV vector, purification is required.

In the related art, as a method of purifying the AAV vector, a method including a filtration step by chromatography using an ion exchange column or an affinity purification column, or tangential flow filtration (TFF) is known. These methods exhibit certain effects in removing impurities from the AAV vector fraction, but are still insufficient. Therefore, as described in WO2022/220273A, JP2008-542015A, JP2010-082567A, or JP2016-013538A, studies on a centrifugal purification method using a zonal rotor have been carried out.

WO2022/220273A discloses a method for producing a complete virus particle, the method including a step of purifying the complete virus particle from a virus particle mixed solution containing a hollow virus particle, an intermediate virus particle, and the complete virus particle, the method including: a step (a) of rotating a zonal rotor at a low speed and disposing the virus particle mixed solution, a liquid (liquid L) having a lower density than the complete virus particle, and a liquid (liquid H1) having a higher density than the liquid L in this order from a rotation axis side of the rotor toward an outer side; a step (b) of driving the zonal rotor after the step (a) in an ultracentrifugal mode to separate the hollow virus particle, the intermediate virus particle, and the complete virus particle; and a step (c) of fractionating and recovering a content of the zonal rotor after the step (b) while recovering a fraction containing the complete virus particle.

JP2008-542015A discloses a rotor for a centrifuge, the rotor including a rotor housing having a substantially cylindrical shape, an inner wall, and a substantially uniform opening portion extending through a center in a length direction of the rotor housing; and a rotor core having a substantially cylindrical shape and being adapted to be accommodated in the substantially uniform opening portion of the rotor housing and having at least two channels on an outer surface, in which at least two sample spaces are defined in the rotor by the channels and the inner wall of the rotor housing, and the rotor for a centrifuge has an L/D ratio in a range of about 0.9 to about 1.3.

JP2010-082567A discloses a centrifuge including a rotor including a sample accommodation portion, a rotor rotation chamber in which the rotor is provided, a drive unit that rotates the rotor, and a first tube including a first passage in which one end is connected to the accommodation portion and that is used to inject or accommodate a density gradient liquid and a sample in the accommodation portion or to recover the sample in the accommodation portion, and a second passage that is used to inject a liquid for pushing out the sample in the accommodation portion to the first passage, the first tube being connected to the other end of the first tube, a first sealing member including a first hole and a second hole that communicate with the first passage and the second passage, a second sealing member that is disposed to face the first sealing member and that includes a third hole and a fourth hole that face the first hole and the second hole of the first sealing member, respectively, and a second tube including a third passage that communicates with the third hole and a fourth passage that communicates with the fourth hole, the third passage and the fourth passage being provided at one end of the second tube, the centrifuge being characterized in that the centrifuge includes a joining and separating unit that joins and separates the first sealing member and the second sealing member.

JP2016-013538A discloses a centrifuge (1), particularly a laboratory centrifuge, including a housing (23) including a lid (2) that separates an inside and an outside of the centrifuge (1), a rotor (5), and a rotor cover (3) for closing the rotor (5), in which the rotor cover (3) and the lid (2) are connected to each other to be attachable and detachable via a holding arm (11) and a holder (12) such that the rotor cover (3) is lifted from the rotor (5) at the same time as the lid (2) is opened and is placed on the rotor (5) at the same time as the lid (2) is closed, and the holding arm (11) is attached to the holder (12) to be attachable and detachable and movable during opening and closing of the lid (2), and the holding arm (11) and the holder (12) are disposed to have a gap space (21) between each other in a case where the lid (2) is closed.

### SUMMARY

In a centrifuge using a zonal rotor, in some cases, a work of replacing a cap attachable and detachable to an attachment port of the zonal rotor during rotation of the zonal rotor is performed. In this case, it is required to attach or detach the cap to or from the zonal rotor during rotation. In the related art, the work of replacing the cap has been performed manually by an operator while paying attention to safety, but there is still room for improvement.

The present disclosed technology provides a jig for cap replacement that can further improve safety of a work of replacing a cap.

A first aspect of the present disclosed technology is a jig for cap replacement that is used in a centrifuge that centrifugally separates a sample by rotating a zonal rotor that accommodates a solution containing the sample and a density gradient medium, the jig for cap replacement being configured to replace a cap attachable to and detachable from an attachment port of the zonal rotor during rotation of the zonal rotor, the jig for cap replacement comprising: an attachment/detachment arm including a holding part configured to hold the cap; and an arm moving mechanism that moves the attachment/detachment arm between an attachment/detachment position at which the cap is attached and detached and a retreat position at which the attachment/detachment arm retreats from the attachment/detachment position.

A second aspect of the present disclosed technology is the jig for cap replacement according to the first aspect, in which the cap includes two types of caps including a first cap and a second cap, the attachment/detachment arm includes a first attachment/detachment arm for attaching and detaching the first cap and a second attachment/detachment arm for attaching and detaching the second cap, and the jig for cap replacement further comprises an arm switching mechanism that selectively switches positions of the first attachment/detachment arm and the second attachment/detachment arm between a first position at which the first attachment/detachment arm faces the attachment port and a second position at which the second attachment/detachment arm faces the attachment port.

A third aspect of the present disclosed technology is the jig for cap replacement according to the second aspect, in which the first cap is a cap that has a connection port to which a pipe for injecting or discharging the solution is connected and is used in a case where the solution is injected into or discharged from the zonal rotor in a state where the first cap is attached to the attachment port, and the second cap is a cap that has higher liquid tightness than the first cap and is used in a case where the zonal rotor is rotated at a second rotation speed higher than a first rotation speed used in a case where the solution is injected or discharged.

A fourth aspect of the present disclosed technology is the jig for cap replacement according to the second aspect, in which the holding part of the first attachment/detachment arm includes a plurality of first claws that are claws for holding the first cap and that abut the first cap in a radial direction, and the holding part of the second attachment/detachment arm includes a plurality of second claws that are claws for holding the second cap and that abut the second cap in a radial direction.

A fifth aspect of the present disclosed technology is the jig for cap replacement according to the fourth aspect, in which the first attachment/detachment arm includes two or more first claws, and the second attachment/detachment arm includes two or more second claws.

A sixth aspect of the present disclosed technology is the jig for cap replacement according to the fourth aspect, in which portions of the first claws and the second claws that abut the first cap and the second cap are formed of a hard resin.

A seventh aspect of the present disclosed technology is the jig for cap replacement according to the fourth aspect, in which the first attachment/detachment arm includes a first air cylinder that moves the plurality of first claws with respect to the first cap, and the second attachment/detachment arm includes a second air cylinder that moves the plurality of second claws with respect to the second cap.

An eighth aspect of the present disclosed technology is the jig for cap replacement according to the second aspect, in which the first attachment/detachment arm is capable of performing an operation of rotating the first cap in a state where the holding part holds the first cap.

A ninth aspect of the present disclosed technology is the jig for cap replacement according to the second aspect, in which the second attachment/detachment arm includes a pressing rod that is a rod-shaped member provided along a longitudinal direction of the second attachment/detachment arm, and the pressing rod includes a pressing part that presses a button provided on the second cap along a movement of the pressing rod in the longitudinal direction.

A tenth aspect of the present disclosed technology is the jig for cap replacement according to the second aspect, in which the arm switching mechanism includes a slide plate part that is a plate-shaped member into which the first attachment/detachment arm and the second attachment/detachment arm are inserted, and a guide rail that guides a slide movement of the slide plate part, and the slide plate part slides between the first position and the second position along the guide rail to selectively switch the positions of the first attachment/detachment arm and the second attachment/detachment arm.

An eleventh aspect of the present disclosed technology is the jig for cap replacement according to the tenth aspect, in which the arm switching mechanism further includes a restriction part that restricts the slide movement of the slide plate part in a state where the slide plate part is held at the first position or the second position.

A twelfth aspect of the present disclosed technology is the jig for cap replacement according to the first aspect, in which the attachment/detachment arm includes a shaft that is a rod-shaped member in which the holding part is provided at one end, the arm moving mechanism includes an arm support part that is a plate-shaped member into which the shaft of the attachment/detachment arm is inserted, and the attachment/detachment arm is moved between the attachment/detachment position and the retreat position by causing the attachment/detachment arm to move via the shaft with respect to the arm support part.

A thirteenth aspect of the present disclosed technology is the jig for cap replacement according to the twelfth aspect, in which the attachment/detachment arm is fixable to the arm support part at the retreat position.

A fourteenth aspect of the present disclosed technology is the jig for cap replacement according to the first aspect, further comprising: an attachment part for positioning the jig for cap replacement at a predetermined position with respect to the zonal rotor and for attaching the jig for cap replacement to an opening of a space in which the zonal rotor is accommodated in the centrifuge.

A fifteenth aspect of the present disclosed technology is a jig for cap replacement that is for replacing a cap attachable to and detachable from an attachment port of a zonal rotor, the jig for cap replacement comprising: an attachment/detachment arm including a holding part that holds the cap; and an arm moving mechanism that moves the attachment/detachment arm between an attachment/detachment position at which the cap is attached and detached and a retreat position at which the attachment/detachment arm retreats from the attachment/detachment position.

The present disclosed technology provides a jig for cap replacement that can further improve safety of a work of replacing a cap.

### BRIEF DESCRIPTION OF THE DRAWINGS

FIG. 1 is a cross-sectional view showing an example of a configuration of a zonal rotor.

FIG. 2 is an external perspective view showing an example of a configuration of a jig for cap replacement.

FIG. 3 is a front view showing an example of a configuration of the jig for cap replacement.

FIG. 4 is a front view showing an example of a usage aspect of the jig for cap replacement.

FIG. 5 is a front view showing an example of a usage aspect of the jig for cap replacement.

FIG. 6 is a front view showing an example of a usage aspect of the jig for cap replacement.

FIG. 7 is a front view showing an example of a usage aspect of the jig for cap replacement.

FIG. 8 is a partially enlarged view showing an example of a usage aspect of the jig for cap replacement.

FIG. 9 is a front view showing a modification example of the jig for cap replacement.

### DESCRIPTION OF EMBODIMENTS

Hereinafter, an embodiment of the present disclosure will be described in detail with reference to the accompanying drawings.

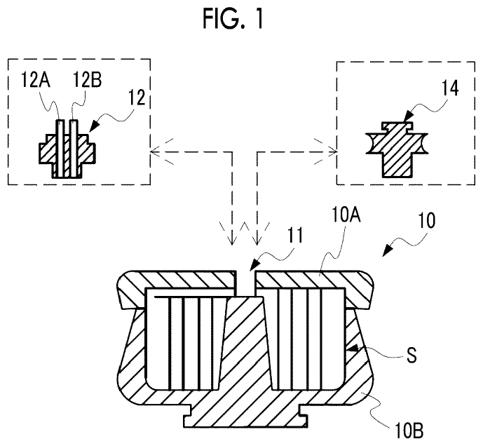

First, the zonal rotor 10 in which the jig for cap replacement 100 according to the present embodiment is used will be described. As shown in FIG. 1 as an example, the zonal rotor 10 is a cylindrical container for centrifugally separating a solution containing a density gradient solution and a sample in the zonal rotor 10. The centrifugation by the zonal rotor 10 is performed by rotating the cylindrical container about a central axis of the cylindrical container as a rotation axis. Examples of the sample include a virus. The virus is produced for gene therapy, but the virus includes a complete virus in which a full-length genome is packaged and a hollow virus that does not include a genome. These are purified by the zonal rotor to extract the complete virus. More specifically, contents described in WO2022/220273A and contents described in WO2018/128688A are referred to for the virus, and are incorporated in the present specification. The virus is not particularly limited, but AAV is preferable. In addition, it is needless to say that a substance (for example, a biological preparation) other than the virus may be used as the sample.

In addition, the density gradient medium is not particularly limited, but may include cesium chloride or sucrose, and may include a substance other than these. As the density gradient medium, a plurality of solutions having different concentrations may be used.

The zonal rotor 10 includes a lid 10A and a rotor body 10B. A space S is formed inside the zonal rotor 10, and the space S accommodates a solution containing a density gradient solution and a sample. The zonal rotor 10 is an example of a “zonal rotor” according to the present disclosed technology.

An attachment port 11 is provided at a center of the lid 10A in a radial direction. The attachment port 11 is an opening connected to the space S inside the zonal rotor 10, and in a case where the zonal rotor 10 is used, a cap is attached to the attachment port 11. The cap of the zonal rotor 10 includes two types of caps including a first cap 12 and a second cap 14. The first cap 12 or the second cap 14 is attachably and detachably attached to the attachment port 11. The attachment port 11 is an example of an “attachment port” according to the present disclosed technology.

The first cap 12 is a cap that is used in a case where the solution is injected to or discharged from the zonal rotor 10 in a state where the first cap 12 is attached to the attachment port 11. The first cap 12 includes connection ports 12A and 12B to which a pipe for injecting or discharging the solution is connected. The first cap 12 is an example of a “cap” and a “first cap” according to the present disclosed technology. In addition, the connection ports 12A and 12B are examples of a “connection port” according to the present disclosed technology.

The second cap 14 is a cap that is used in a case where the zonal rotor 10 is rotated at a rotation speed (for example, 30,000 rpm) higher than a rotation speed (for example, 3,000 rpm) in a case where the solution is injected or discharged. The second cap 14 has higher liquid tightness than the first cap 12 in a case where the second cap 14 is attached to the zonal rotor 10. The second cap 14 is an example of a “cap” and a “second cap” according to the present disclosed technology. In the following description, the first cap 12 and the second cap 14 are also simply referred to as a “cap” in a case where it is not necessary to distinguish between the first cap 12 and the second cap 14.

Next, a flow of the centrifugation by the zonal rotor 10 will be described. First, the solution is injected into the space S inside the zonal rotor 10 during low-speed rotation (for example, 3,000 rpm). Specifically, the solution is injected from the connection port 12A of the first cap 12, and the solution is gradually filled from the outer peripheral side of the space S. In this case, the solution includes only the density gradient medium. By the low-speed rotation of the zonal rotor 10, the density gradient medium in the space S is separated according to the density. That is, a density gradient of the solution is formed from the outer peripheral side toward the inner peripheral side along the radial direction of the zonal rotor 10.

Next, after the density gradient is formed, the solution containing the sample is injected into the space S of the zonal rotor 10 during the low-speed rotation of the zonal rotor 10. Specifically, the solution is injected from the connection port 12B of the first cap 12, and the solution is gradually filled from the inner peripheral side of the zonal rotor 10.

Thereafter, in the zonal rotor 10, the first cap 12 is removed and the second cap 14 is attached. That is, the first cap 12 and the second cap 14 are exchanged. After the second cap 14 is attached, the zonal rotor 10 is rotated at a high speed (for example, 30,000 rpm). As a result, the sample is centrifugally separated in the density gradient.

Then, after the centrifugal separation of the sample is completed, the high-speed rotation ends and the low-speed rotation proceeds. During the low-speed rotation, the second cap 14 is exchanged for the first cap 12. Further, during the low-speed rotation, a solution having a higher concentration than the density gradient medium inside the space S is injected. Specifically, the solution is injected from the connection port 12A of the first cap 12, the solution is gradually injected from the outer peripheral side of the space S, and the solution containing the centrifugally separated sample and the density gradient medium is discharged from the inner peripheral side through the connection port 12B. In this way, the sample centrifugally separated by rotating the zonal rotor 10 is obtained.

As described above, in the centrifugation step using the zonal rotor 10, a work of replacing the first cap 12 and the second cap 14 (hereinafter, also simply referred to as a “cap replacement work”) occurs. Since the cap replacement work is performed during the rotation of the zonal rotor 10, it is necessary to pay attention to the safety of the work. Therefore, in the present embodiment, the cap replacement work is performed on the zonal rotor 10 during rotation using the jig for cap replacement 100.

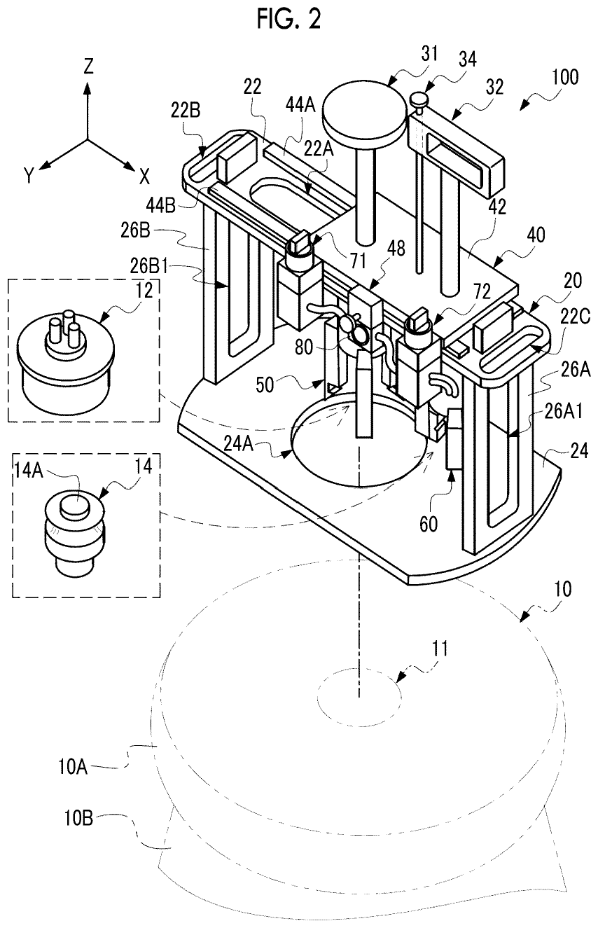

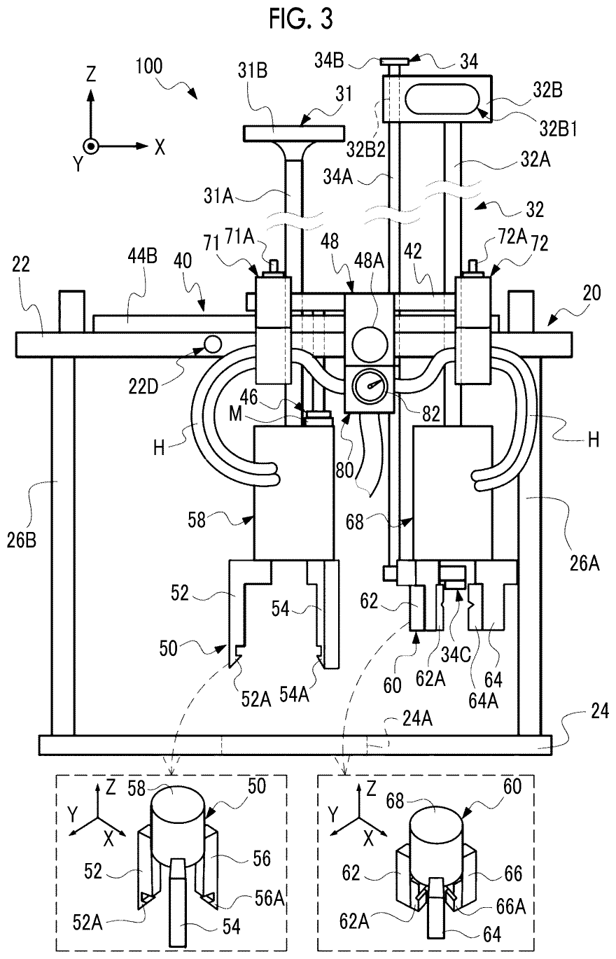

As shown in FIGS. 2 and 3 as an example, the jig for cap replacement 100 is a jig for replacing the first cap 12 and the second cap 14 attachable to and detachable from the attachment port 11 of the zonal rotor 10 during rotation of the zonal rotor 10. The jig for cap replacement 100 is installed at a position above the zonal rotor 10 and facing the lid 10A, and is operated by an operator to realize the cap replacement work.

In the following description, for convenience of description, the width direction, the front-rear direction (also referred to as a depth direction), and the height direction of the jig for cap replacement 100 are indicated by three arrows X, Y, and Z. First, the height direction is indicated by the arrow Z, and an arrow Z direction indicated by the arrow Z is defined as an upward direction of the jig for cap replacement 100, and the opposite direction is defined as a downward direction. The height direction is a vertical direction. The width direction is indicated by the arrow X orthogonal to the arrow Z, a direction indicated by the arrow X is referred to as a right direction of the jig for cap replacement 100, and an opposite direction thereof is referred to as a left direction. The front-rear direction is indicated by the arrow Y in a direction orthogonal to the arrow Z and the arrow X, a direction indicated by the arrow Y is referred to as a front direction of the jig for cap replacement 100, and an opposite direction thereof is referred to as a rear direction. For example, the operator of the jig for cap replacement 100 performs the work while standing on the front side of the jig for cap replacement 100. In addition, hereinafter, the expressions using the side, such as an upper side, a lower side, a left side, a right side, a front side, and a rear side, have the same meaning as the expressions using the direction.

The jig for cap replacement 100 includes a base part 20, a first attachment/detachment arm 31, a second attachment/detachment arm 32, and a slide mechanism 40. In the following description, the first attachment/detachment arm 31 and the second attachment/detachment arm 32 are also simply referred to as an “arm” in a case where it is not necessary to distinguish between the first attachment/detachment arm 31 and the second attachment/detachment arm 32. The first attachment/detachment arm 31 is an example of a “attachment/detachment arm” and a “first attachment/detachment arm” according to the present disclosed technology, and the second attachment/detachment arm 32 is an example of a “attachment/detachment arm” and a “second attachment/detachment arm” according to the present disclosed technology.

The base part 20 is a portion constituting a main body structure of the jig for cap replacement 100. The base part 20 includes an upper plate part 22, a lower plate part 24, and a pair of side plate parts 26A and 26B. The upper plate part 22 is a plate-shaped member that forms an upper portion of the base part 20. The upper plate part 22 has, for example, a rectangular parallelepiped shape having a longitudinal direction along a left-right direction and a plate thickness direction along an up-down direction. The upper plate part 22 is formed along the longitudinal direction and has a long hole 22A that is formed to be penetrated in the plate thickness direction. The slide mechanism 40 is attached to the upper plate part 22. In addition, the first attachment/detachment arm 31 and the second attachment/detachment arm 32 are inserted into the long hole 22A.

In addition, holding parts 22B and 22C are formed at both ends of the upper plate part 22 in the longitudinal direction. The holding parts 22B and 22C are through-holes formed along the plate thickness direction, and the jig for cap replacement 100 can be held by hooking fingers on the through-holes.

The lower plate part 24 is a plate-shaped member that forms a lower portion of the base part 20. The lower plate part 24 has, for example, a substantially rectangular parallelepiped shape having a longitudinal direction in the left-right direction and a plate thickness direction in the up-down direction. The lower plate part 24 is wider than the upper plate part 22 in the front-rear direction. In addition, both end edges of the lower plate part 24 in the left-right direction are arc-shaped. Here, the curvature of the arc shape corresponds to the curvature of the circular opening of the accommodation portion of the zonal rotor 10 of the centrifuge.

In addition, a through-hole 24A is formed at the center of the lower plate part 24. The through-hole 24A is formed at a position facing the attachment port 11 of the zonal rotor 10. An opening diameter of the through-hole 24A is set to a size through which the first holding part 50 and the second holding part 60 described below can pass.

The side plate parts 26A and 26B are provided on the left and right sides of the base part 20 and are members that connect the upper plate part 22 and the lower plate part 24. For example, the side plate parts 26A and 26B are plate-shaped members erected between the upper plate part 22 and the lower plate part 24. The side plate parts 26A and 26B have the up-down direction as a longitudinal direction and the left-right direction as a plate thickness direction. The side plate parts 26A and 26B each have through-holes 26A1 and 26B1. The through-holes 26A1 and 26B1 are formed to be penetrated along the plate thickness direction. As a result, the side plate parts 26A and 26B are lightened. Sizes of the through-holes 26A1 and 26B1 in the front-rear direction and the up-down direction are appropriately set according to strength and the like required for the side plate parts 26A and 26B.

The base part 20 is made of, for example, aluminum. Each part constituting the base part 20 is fastened to each other by, for example, screws.

The first attachment/detachment arm 31 is a portion for attaching and detaching the first cap 12 via the first holding part 50. The first attachment/detachment arm 31 is attached to the upper plate part 22 via the slide mechanism 40. The first attachment/detachment arm 31 includes the first holding part 50. The first holding part 50 is a portion for holding the first cap 12.

The first attachment/detachment arm 31 includes a shaft 31A and a handle 31B. The shaft 31A is a circular rod-shaped member having a longitudinal direction along the up-down direction. The shaft 31A is inserted into a slide plate part 42 described below in a state of being movable along the up-down direction. The handle 31B is provided at an upper end of the shaft 31A. The handle 31B is a disk-shaped operating member in a top view, and a central axis of the disk shape matches a central axis of the shaft 31A. That is, the handle 31B is provided at a position coaxial with the shaft 31A. The operator can hook a finger on an outer peripheral portion of the handle 31B and grip the handle 31B.

Here, although a form example in which the handle 31B has a disk shape has been described, this is merely an example. The handle 31B may have any shape as long as the first attachment/detachment arm 31 can be rotationally operated or moved in the up-down direction, and may be, for example, an elliptical shape or a polygonal shape.

In addition, the first holding part 50 is provided at a lower end of the shaft 31A. Details of the first holding part 50 will be described below.

The second attachment/detachment arm 32 is a portion for attaching and detaching the second cap 14 via the second holding part 60. The second attachment/detachment arm 32 is attached to the upper plate part 22 via the slide mechanism 40. The second attachment/detachment arm 32 includes the second holding part 60. The second holding part 60 is a portion for holding the second cap 14.

The second attachment/detachment arm 32 includes a shaft 32A and a handle 32B. The shaft 32A is a circular rod-shaped member having a longitudinal direction along the up-down direction. The shaft 32A is inserted into a slide plate part 42 described below in a state of being movable along the up-down direction. The handle 32B is provided at an upper end of the shaft 32A. The handle 32B is a rectangular parallelepiped-shaped operating member in a front view, and has a long hole 32B1 that is formed to be penetrated along the front-rear direction. The operator can hook a finger on the long hole 32B1 to grip the handle 32B. The shape of the handle 32B is not particularly limited as long as the operator can hold the handle 32B.

In addition, the second holding part 60 is provided at a lower end of the shaft 32A. Details of the second holding part 60 will be described below.

In addition, the second attachment/detachment arm 32 includes a pressing rod 34 that is a rod-shaped member provided along a longitudinal direction of the second attachment/detachment arm 32. The pressing rod 34 includes a shaft 34A, an operating part 34B, and a pressing part 34C. The shaft 34A is a circular rod-shaped member having a longitudinal direction along the up-down direction. The shaft 34A extends along the shaft 32A of the second attachment/detachment arm 32. In other words, the shaft 34A is provided side by side with the shaft 32A in the left-right direction. In addition, the shaft 34A is inserted into a through-hole 32B2 provided in the handle 32B. Further, the shaft 34A is inserted into the slide plate part 42 described below in a state of being movable along the up-down direction. The pressing rod 34 is an example of a “pressing rod” according to the present disclosed technology.

In the pressing rod 34, the operating part 34B is provided at an upper end of the shaft 34A. The operating part 34B is a flat plate-shaped portion having a plate thickness direction along an axial direction of the shaft 34A. The pressing part 34C is provided at a lower end of the shaft 34A. The pressing part 34C is a portion for pressing a button 14A provided on the second cap 14. The pressing part 34C is a portion that extends in a direction orthogonal to the axial direction of the shaft 34A and from the shaft 34A toward the second holding part 60. In the pressing part 34C, a distal end portion of a portion extending from the shaft 34A is capable of abutting on the button 14A of the second cap 14. The pressing part 34C is an example of a “pressing part” according to the present disclosed technology.

The slide mechanism 40 is a mechanism that can selectively switch positions of the first attachment/detachment arm 31 and the second attachment/detachment arm 32. Specifically, the slide mechanism 40 can selectively switch the first attachment/detachment arm 31 and the second attachment/detachment arm 32 between a position at which the first attachment/detachment arm 31 faces the attachment port 11 and a position at which the second attachment/detachment arm 32 faces the attachment port 11.

The slide mechanism 40 includes a slide plate part 42 and a pair of guide rails 44A and 44B. The slide plate part 42 is supported by the pair of guide rails 44A and 44B and is movable on the pair of guide rails 44A and 44B. The slide plate part 42 is a plate-shaped member having, for example, a rectangular parallelepiped shape having a longitudinal direction along the left-right direction and a plate thickness direction along the up-down direction. The slide plate part 42 has a width along the front-rear direction to the same extent as the upper plate part 22 and has a length in the left-right direction of about half of the upper plate part 22. The slide mechanism 40 is an example of an “arm switching mechanism” according to the present disclosed technology, the slide plate part 42 is an example of a “slide plate part” according to the present disclosed technology, and the pair of guide rails 44A and 44B are examples of a “guide rail” according to the present disclosed technology.

The slide plate part 42 supports the first attachment/detachment arm 31 and the second attachment/detachment arm 32. Specifically, the first attachment/detachment arm 31 and the second attachment/detachment arm 32 are inserted into the slide plate part 42 along the plate thickness direction. More specifically, as described above, the shaft 31A of the first attachment/detachment arm 31 and the shaft 32A of the second attachment/detachment arm 32 are inserted into the slide plate part 42. In other words, the slide plate part 42 functions as an arm support part that supports the first attachment/detachment arm 31 and the second attachment/detachment arm 32. In this case, the slide plate part 42 is an example of an “arm support part” according to the present disclosed technology.

The first attachment/detachment arm 31 and the second attachment/detachment arm 32 are provided side by side in the left-right direction. Specifically, the first attachment/detachment arm 31 and the second attachment/detachment arm 32 are provided side by side in the longitudinal direction of the slide plate part 42.

The first attachment/detachment arm 31 is movable along the up-down direction with respect to the slide plate part 42 via the shaft 31A. In addition, as a result, the second attachment/detachment arm 32 is movable along the up-down direction with respect to the slide plate part 42 via the shaft 32A. The first attachment/detachment arm 31 and the second attachment/detachment arm 32 are movable between an attachment/detachment position and a retreat position described below. In other words, the slide mechanism 40 including the slide plate part 42 also functions as an arm moving mechanism that moves the arm between the attachment/detachment position and the retreat position. In this case, the slide mechanism 40 is an example of an “arm moving mechanism” according to the present disclosed technology.

The pair of guide rails 44A and 44B are rail members that guide the slide movement of the slide plate part 42. The pair of guide rails 44A and 44B are formed on, for example, an upper surface of the upper plate part 22 and extend along the left-right direction. The guide rail 44A of the pair of guide rails 44A and 44B is provided on a rear side of the long hole 22A of the upper plate part 22. In addition, the guide rail 44B of the pair of guide rails 44A and 44B is provided on a front side of the long hole 22A of the upper plate part 22. In other words, the long hole 22A is formed between the pair of guide rails 44A and 44B. In addition, the pair of guide rails 44A and 44B supports both end portions of the slide plate part 42 in the front-rear direction from below. The first attachment/detachment arm 31 and the second attachment/detachment arm 32 inserted into the slide plate part 42 are disposed at positions passing through the long hole 22A. That is, the slide plate part 42 is capable of sliding in the left-right direction along the pair of guide rails 44A and 44B.

In addition, an arm fixing part 46 is provided on a lower surface of the slide plate part 42. The arm fixing part 46 is a rod-shaped portion that extends from a lower surface of the slide plate part 42. A magnetized member is provided at a lower end of the arm fixing part 46. The magnetized member of the arm fixing part 46 is magnetically attachable to a magnet M provided on an upper surface of the first holding part 50. As a result, the first attachment/detachment arm 31 is fixed to the slide plate part 42 at a predetermined height. Here, an adsorption force between the magnetized member of the arm fixing part 46 and the magnet M is set to a level at which the operator can release the adsorption by pressing down the first attachment/detachment arm 31 and a level at which the first attachment/detachment arm 31 does not fall due to its own weight.

In addition, although not shown, an arm fixing part for fixing the second attachment/detachment arm 32 may be provided on a lower surface of the slide plate part 42. The arm fixing part for fixing the second attachment/detachment arm 32 has the same configuration as the arm fixing part 46. In addition, in this case, a magnet is provided on an upper surface of the second holding part 60 of the second attachment/detachment arm 32.

In addition, the slide mechanism 40 further includes a slide restriction part 48. The slide restriction part 48 restricts the slide movement of the slide plate part 42. Specifically, the slide restriction part 48 is attached to a front surface side of the slide plate part 42. The slide restriction part 48 includes a plunger 48A. The slide restriction part 48 is an example of a “restriction part” according to the present disclosed technology.

The plunger 48A is provided to be movable along the front-rear direction. The plunger 48A is provided at a position where a distal end thereof is insertable into a hole 22D provided on a front end surface of the upper plate part 22. The hole 22D is provided in plurality on the front end surface of the upper plate part 22 along a longitudinal direction (that is, the left-right direction) of the upper plate part 22. A position of the hole 22D is appropriately set according to a position where the slide plate part 42 is to be held.

In a case where the slide plate part 42 is at a predetermined position, the operator pushes the plunger 48A toward the upper plate part 22, so that a distal end part of the plunger 48A is engaged with the hole 22D. As a result, the slide plate part 42 is held at a predetermined position with respect to the upper plate part 22 via the plunger 48A.

The first holding part 50 is a portion for holding the first cap 12. The first holding part 50 is provided at a lower end of the shaft 31A in the first attachment/detachment arm 31. The first holding part 50 includes claws 52, 54, and 56 and a holding part body 58. The claws 52, 54, and 56 are claws for holding the first cap 12 radially. The claws 52, 54, and 56 are examples of “a plurality of first claws” according to the present disclosed technology. Here, the claws 52, 54, and 56 are disposed at equal intervals (that is, 120-degree intervals) in a circumferential direction with respect to the first cap 12. A base end part of each of the claws 52, 54, and 56 is attached to a lower end part of the holding part body 58. The base end parts of the claws 52, 54, and 56 move radially with respect to the holding part body 58, so that distal end parts 52A, 54A, and 56A of the claws 52, 54, and 56 hold an outer peripheral portion of the first cap 12.

In the claws 52, 54, and 56, a portion that abuts on the first cap 12 is formed of a hard resin material (for example, monomer cast nylon). Here, a portion of the claws 52, 54, and 56 on a radial inner side is formed of a hard resin material. Therefore, the durability is excellent, and breakage or wear debris that may occur due to friction in a case of being in contact with the first cap 12 is suppressed. Other portions of the claws 52, 54, and 56 are made of aluminum. The shape and rigidity of the claws 52, 54, and 56 are appropriately set based on an outer peripheral surface shape of the first cap 12, which is a holding target, a holding force required for the holding, and the like. The hard resin is preferably a material having heat resistance of 100° C. or higher, and is preferably an engineering plastic. Specific examples of the engineering plastic include polyamide (for example, nylon), polycarbonate, polyacetal, modified polyphenylene ether, and polybutylene terephthalate, and polyamide is particularly preferable. In addition, the hard resin may be a super engineering plastic.

The zonal rotor is used for purification in a manufacturing step of a biopharmaceutical. Therefore, a clean environment is required for the manufacturing facility. Since the above-described hard resin used for the claws 52, 54, and 56 does not generate wear debris, it is suitable for the manufacturing step of the biopharmaceutical.

The holding part body 58 supports the claws 52, 54, and 56 and accommodates a drive mechanism (not shown) for driving the claws 52, 54, and 56. Specifically, the holding part body 58 has a cylindrical housing, and the claws 52, 54, and 56 are attached to a lower end part of the housing. In addition, the drive mechanism is accommodated inside the housing of the holding part body 58. The lower end of the shaft 31A is attached to an upper surface of the housing.

Although the details will be described below, the holding part body 58 includes an air cylinder as the drive mechanism. Compressed air for operating the air cylinder is supplied to the holding part body 58 via a hose H.

The second holding part 60 is a portion for holding the second cap 14. The second holding part 60 is provided at a lower end of the shaft 32A in the second attachment/detachment arm 32. The second holding part 60 includes claws 62, 64, and 66 and a holding part body 68. The claws 62, 64, and 66 are claws for holding the second cap 14 radially. The claws 62, 64, and 66 are examples of “a plurality of second claws” according to the present disclosed technology. Here, the claws 62, 64, and 66 are disposed at equal intervals (that is, 120-degree intervals) in a circumferential direction with respect to the second cap 14. A base end part of each of the claws 62, 64, and 66 is attached to a lower end part of the holding part body 68. The base end parts of the claws 62, 64, and 66 move radially with respect to the holding part body 68, so that abutting parts 62A, 64A, and 66A of the claws 62, 64, and 66 hold an outer peripheral portion of the second cap 14.

In the claws 62, 64, and 66, the abutting parts 62A, 64A, and 66A are formed of a hard resin material. The abutting parts 62A, 64A, and 66A are formed of, for example, monomer cast nylon. The shape and rigidity of the abutting parts 62A, 64A, and 66A are appropriately set based on an outer peripheral surface shape of the second cap 14, which is a holding target, a holding force required for the holding, and the like.

The holding part body 68 supports the claws 62, 64, and 66 and accommodates a drive mechanism (not shown) for driving the claws 62, 64, and 66. Since the configuration of the holding part body 68 is the same as that of the holding part body 58 of the first attachment/detachment arm 31, detailed description thereof will be omitted.

In addition, in the following description, the claws 52, 54, and 56 and the claws 62, 64, and 66 are also simply referred to as “claws” in a case where it is not necessary to distinguish between the claws 52, 54, and 56 and the claws 62, 64, and 66.

In addition, the jig for cap replacement 100 according to the present embodiment includes air supply switches 71 and 72 and a regulator 80. The air supply switches 71 and 72 are switches for changing a supply path of the compressed air. As described above, the first holding part 50 and the second holding part 60 include the air cylinder.

Specifically, a path of the compressed air supplied to the air cylinder is switched by operating an operating part 71A of the air supply switch 71 and an operating part 72A of the air supply switch 72. In a case where the supply path of the compressed air is switched, a state of extension and contraction of the air cylinder is changed. That is, the claws approach or separate from the cap.

The regulator 80 is a device for reducing the pressure of the compressed air supplied from an air supply source (not shown) and supplying the reduced pressure to the jig for cap replacement 100. A pressure display panel 82 is provided on a front surface of the regulator 80. As a result, the operator can visually recognize the pressure used in the jig for cap replacement 100. The air supply source may be, for example, a compressed air pipe used in a facility where the jig for cap replacement 100 is used, or a compressed air tank.

The air supply switches 71 and 72 and the regulator 80 are attached to the slide plate part 42. Specifically, the air supply switches 71 and 72 and the regulator 80 are attached to a front surface side of the slide plate part 42. The air supply switches 71 and 72 and the regulator 80 are movable along the left-right direction in conjunction with the slide movement of the slide plate part 42.

Here, although a form example has been described in which the air supply switches 71 and 72 and the regulator 80 are attached to the jig for cap replacement 100, this is merely an example. The air supply switches 71 and 72 and/or the regulator 80 may be provided separately from the jig for cap replacement 100.

The operator of the jig for cap replacement 100 generally performs the replacement work while being positioned on a front side of the jig for cap replacement 100. By attaching the regulator 80 to a front side of the slide plate part 42, it is easy to visually recognize the pressure of the compressed air. In addition, by attaching the air supply switches 71 and 72 to the front side of the slide plate part 42, it is easy to perform the switching operation of the air supply system. That is, it is easy to perform an operation of bringing the claws close to the cap or separating the claws from the cap.

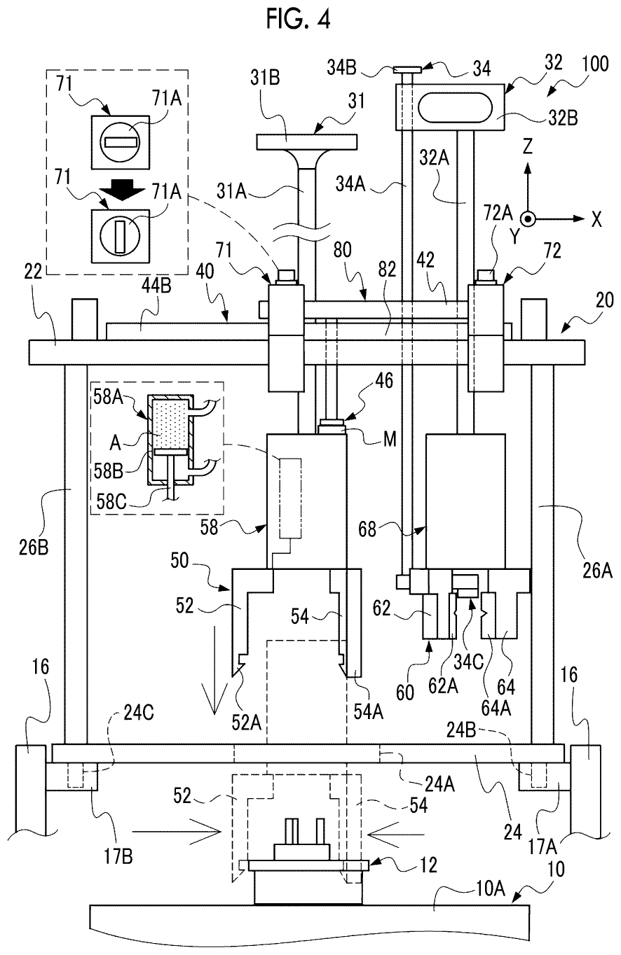

Next, a usage example of the jig for cap replacement 100 according to the present embodiment will be described with reference to FIGS. 4 to 8. In FIGS. 4 to 8, for convenience of description, some configurations (for example, the slide restriction part 48 and the regulator 80) of the jig for cap replacement 100 may be omitted. As shown in FIG. 4 as an example, first, the first cap 12 attached to the zonal rotor 10 is removed during the low-speed rotation of the zonal rotor 10.

In this case, brackets 17A and 17B are provided on an opening edge 16 of the accommodation portion of the zonal rotor 10 of the centrifuge. The brackets 17A and 17B are portions that protrude inward along a radial direction from an inner peripheral surface of the opening edge 16. The brackets 17A and 17B are formed with through-holes. Then, positioning pins 24B and 24C that protrude from a lower surface of the lower plate part 24 of the jig for cap replacement 100 are respectively inserted into the through-holes provided in the brackets 17A and 17B. The positioning pins 24B and 24C are examples of an “attachment part” according to the present disclosed technology. In the present example, the jig for cap replacement 100 comprises the positioning pins 24B and 24C as the attachment part in addition to the body including the base part 20 described above. The attachment part is a part of the jig for cap replacement 100 and is a part for attaching the body (in other words, the jig for cap replacement 100 itself) to the zonal rotor 10.

The positions of the brackets 17A and 17B and the positions of the through-holes are predetermined positions. Therefore, by inserting the positioning pins 24B and 24C of the jig for cap replacement 100 into the through-holes of the brackets 17A and 17B, the jig for cap replacement 100 is attached to the opening edge 16 of the accommodation portion of the zonal rotor 10 at a predetermined position. As a result, the jig for cap replacement 100 is attached to the zonal rotor 10 in the accommodation portion of the centrifuge at a predetermined position.

Here, although a form example has been described in which the number of positioning pins is two and the number of corresponding brackets is also two, this is merely an example. The number of positioning pins may be two or more, and the number of corresponding brackets may also be two or more.

After the jig for cap replacement 100 is attached, the first attachment/detachment arm 31 is set to a position facing the attachment port 11 (hereinafter, also simply referred to as a “first slide position”). Here, since the first cap 12 is attached to the attachment port 11, the first attachment/detachment arm 31 faces the first cap 12. The first slide position is an example of a “first position” according to the present disclosed technology.

In the first slide position, the slide plate part 42 is held by the slide restriction part 48 (see FIG. 3). In addition, the first attachment/detachment arm 31 is held at a retreat position that is a position retreated from the attachment/detachment position described below. Specifically, the first holding part 50 is positioned at a predetermined height from the first cap 12 and is positioned at a position that does not interfere with the first cap 12. In addition, in the retreat position, the position is a position that does not interfere with other members of the jig for cap replacement 100 even in a switching operation of the arm described below. In this position, the magnetized member of the arm fixing part 46 and the magnet M are adsorbed.

Then, the handle 31B of the first attachment/detachment arm 31 is held by the operator, and the handle 31B is further pushed downward, so that the first attachment/detachment arm 31 moves downward. In this case, the adsorption between the magnetized member of the arm fixing part 46 and the magnet M is released in conjunction with the operation of pushing the first attachment/detachment arm 31 downward.

The first attachment/detachment arm 31 that moves downward passes through the through-hole 24A of the lower plate part 24. Then, the first attachment/detachment arm 31 moves to the attachment/detachment position. Here, the attachment/detachment position is a position at which the arm can attach to and detach the cap to and from the zonal rotor 10. In other words, the attachment/detachment position is a height at which the arm can attach or detach the cap to or from the zonal rotor 10. Specifically, the first attachment/detachment arm 31 descends to a position where the claws 52, 54, and 56 (see also FIG. 2) of the first holding part 50 face the outer peripheral surface of the first cap 12 in the radial direction.

In this state, the operator operates the operating part 71A of the air supply switch 71. Here, an example of an operation of twisting the operating part 71A by 90 degrees is shown. As a result, the path of the compressed air supplied to the first holding part 50 is switched, and the air cylinder 58A accommodated inside the holding part body 58 is operated. The claws 52, 54, and 56 receive the power from the air cylinder 58A and move in a direction approaching the outer peripheral surface of the first cap 12. The air cylinder 58A is an example of a “first air cylinder” according to the present disclosed technology. Here, the air cylinder 58A comprises a cylinder body 58B and a rod 58C. Compressed air A is accommodated inside the cylinder body 58B. The rod 58C moves by supplying the compressed air A to the head side or the rod side of the cylinder body 58B. Here, an example is shown in which the compressed air is supplied to the head side of the cylinder body 58B and the rod 58C moves in a direction of protruding from the cylinder body 58B. As described above, the air cylinder 58A generates power. Here, although only one air cylinder 58A is shown, it is needless to say that a plurality of air cylinders may be provided in the holding part body 58. For example, an air cylinder corresponding to each claw may be provided.

In addition, since the compressed air A supplied to the air cylinder 58A is a compressible fluid, the volume changes in a case of receiving an external force. That is, in a case where the claws 52, 54, and 56 come into contact with the first cap 12, the claws 52, 54, and 56 may receive a reaction force from the first cap 12. This reaction force is transmitted to the compressed air A inside the cylinder body 58B via the rod 58C. In this case, the compressed air A can absorb a part of the reaction force by changing the volume. That is, the air cylinder 58A also functions as a damper that absorbs the reaction force received from the claws 52, 54, and 56.

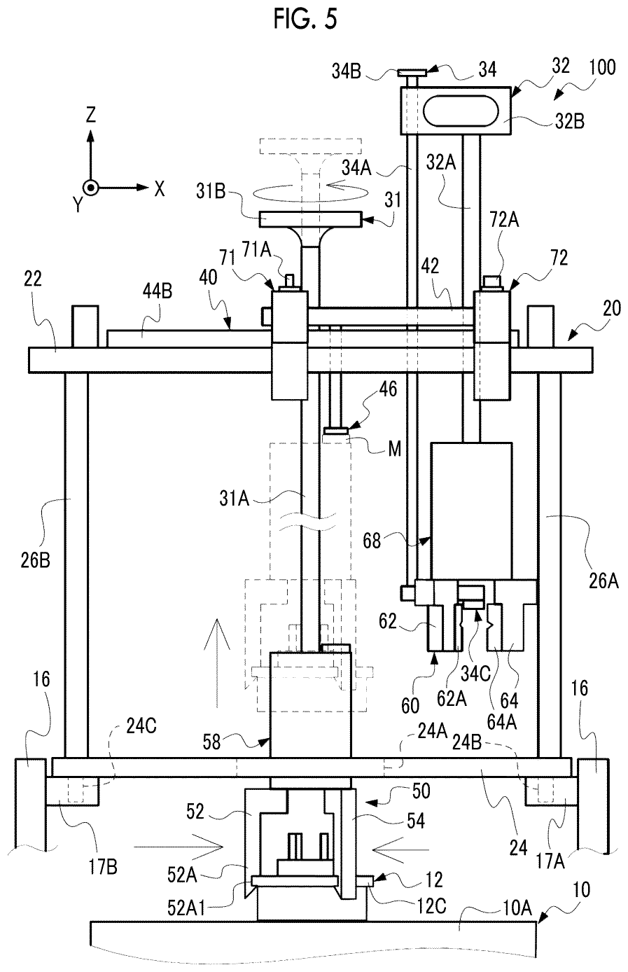

As shown in FIG. 5 as an example, the first cap 12 is held via the claws 52, 54, and 56 of the first holding part 50. Specifically, in a case of describing the claws 52 as an example, a recessed portion 52A1 that is provided at the distal end part 52A of the claw 52 and that is recessed in the radial direction is engaged with a protruding portion 12C provided along the circumferential direction of the first cap 12. As a result, the contact area between the claw 52 and the first cap 12 is increased, the holding force is increased, and the first cap 12 is easily supported from below. As described above, the first holding part 50 holds the first cap 12.

Here, in a case of attaching and detaching the first cap 12, an operation of removing the first cap 12 while rotating the first cap 12 is required. Therefore, the first attachment/detachment arm 31 is capable of performing an operation of rotating the first cap 12 in a state where the first holding part 50 holds the first cap 12. For example, the handle 31B is rotationally operated by the operator, so that the first holding part 50 is also rotationally operated in conjunction therewith, and the first cap 12 is removed from the zonal rotor 10.

After the first cap 12 is removed, the handle 31B is pulled upward, so that the first attachment/detachment arm 31 moves upward. That is, the first cap 12 held by the first holding part 50 is pulled up. The first attachment/detachment arm 31 that has moved upward is held at the retreat position. Specifically, the first attachment/detachment arm 31 is fixed at the retreat position by adsorbing the magnetized member of the arm fixing part 46 and the magnet M.

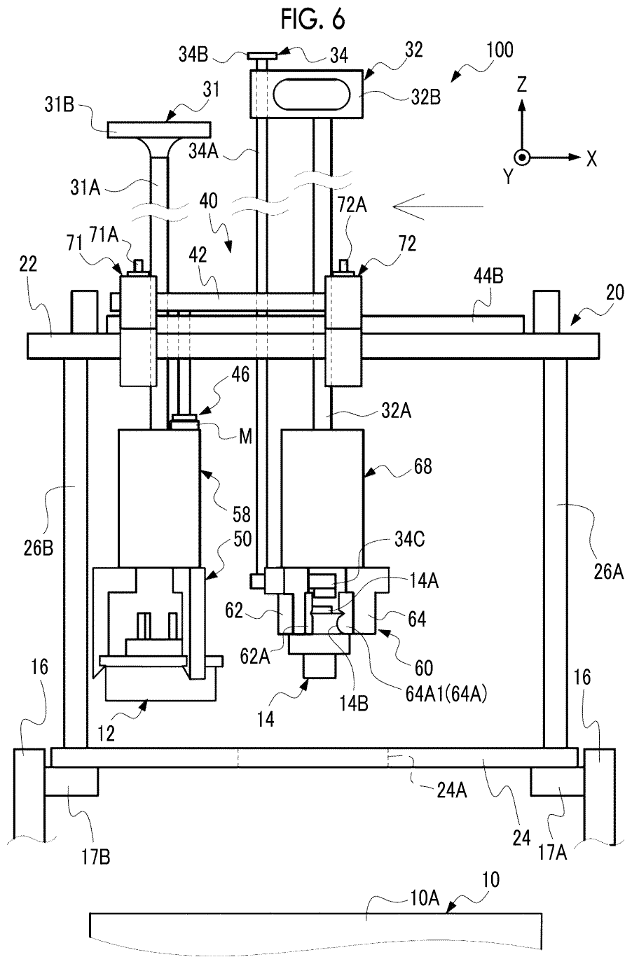

After the first cap 12 is removed, the second cap 14 is attached. As shown in FIG. 6 as an example, first, the slide plate part 42 slides from the first slide position to the second slide position. Here, the second slide position is a position at which the second attachment/detachment arm 32 faces the attachment port 11 of the zonal rotor 10. That is, the slide mechanism 40 can selectively switch the positions of the first attachment/detachment arm 31 and the second attachment/detachment arm 32 between the first slide position and the second slide position. The second slide position is an example of a “second position” according to the present disclosed technology.

Specifically, the plunger 48A of the slide restriction part 48 is operated by the operator, and the engagement between the plunger 48A and the upper plate part 22 is released. Then, the slide plate part 42 is moved in the left-right direction along the guide rails 44A and 44B. Here, the slide plate part 42 is moved in the left direction. The first attachment/detachment arm 31 and the second attachment/detachment arm 32 also move together with the movement of the slide plate part 42. In a case where the slide plate part 42 moves to the second slide position, the operator operates the plunger 48A of the slide restriction part 48 again to engage the plunger 48A with the upper plate part 22. As a result, the slide plate part 42 is held at the second slide position. As described above, the slide plate part 42 of the slide mechanism 40 slides between the first slide position and the second slide position, so that the positions of the first attachment/detachment arm 31 and the second attachment/detachment arm 32 are selectively switched.

The second holding part 60 of the second attachment/detachment arm 32 holds the second cap 14. Specifically, the second cap 14 is held via the claws 62, 64, and 66 of the second holding part 60. More specifically, in a case of describing the claws 64 as an example, a protruding portion 64A1 that is provided at the abutting part 64A of the claw 64 and that protrudes in the radial direction is engaged with a curved recessed portion 14B provided along the circumferential direction of the second cap 14. As a result, the contact area between the claw 64 and the second cap 14 is increased, the holding force is increased, and the second cap 14 is easily supported from below. As described above, the second holding part 60 holds the second cap 14.

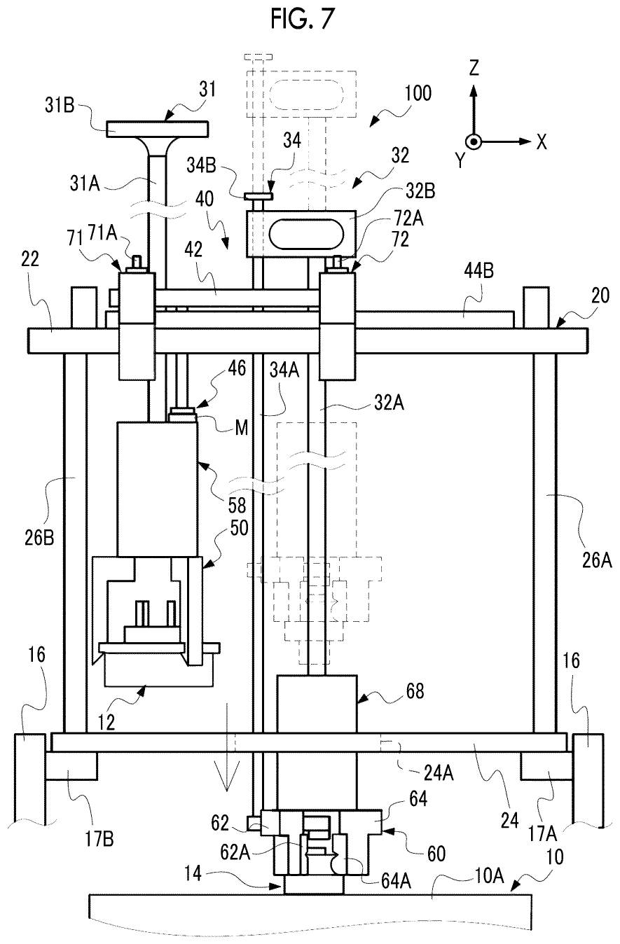

As shown in FIG. 7 as an example, the handle 32B of the second attachment/detachment arm 32 is held by the operator, and the handle 32B is further pushed downward, so that the second attachment/detachment arm 32 moves downward. In this case, the adsorption between the magnetized member of the arm fixing part (not shown) and the magnet (not shown) is released in conjunction with the operation of pushing the second attachment/detachment arm 32 downward.

The second attachment/detachment arm 32 that moves downward passes through the through-hole 24A of the lower plate part 24. Then, the second attachment/detachment arm 32 moves to the attachment/detachment position. Specifically, the second cap 14 is attached to the zonal rotor 10, and the second attachment/detachment arm 32 descends to a position where the claws 62, 64, and 66 can be separated from the second cap 14.

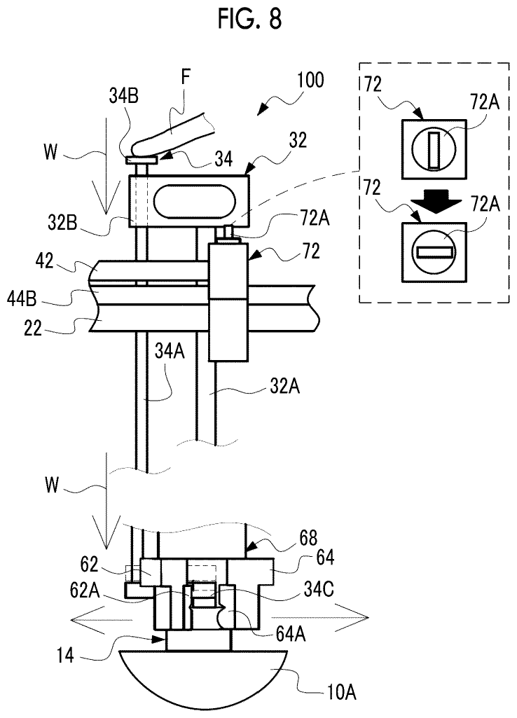

As shown in FIG. 8 as an example, the second attachment/detachment arm 32 is pushed to the attachment/detachment position, and the second cap 14 is attached to the attachment port 11 of the zonal rotor 10. Then, in a state where the second attachment/detachment arm 32 has moved to the attachment/detachment position, the operator operates the operating part 72A of the air supply switch 72. Here, an example of an operation of twisting the operating part 72A by 90 degrees is shown. As a result, the path of the compressed air supplied to the second holding part 60 is switched, and the air cylinder (not shown) accommodated inside the holding part body 68 is operated. Since the configuration of the air cylinder of the holding part body 68 is the same as that of the air cylinder 58A, the details thereof will be omitted. The claws 62, 64, and 66 receive the power from the air cylinder and move in a direction of separating from the outer peripheral surface of the second cap 14.

After the holding of the second cap 14 by the second holding part 60 is released, the second attachment/detachment arm 32 is pulled from the attachment/detachment position to the retreat position. As described above, the work of removing the first cap 12 and attaching the second cap 14 is performed.

In addition, in a case of removing the second cap 14 and attaching the first cap 12, the procedure described using FIGS. 4 to 8 may be performed in the reverse order. In a simple description, first, the second cap 14 is removed using the second attachment/detachment arm 32.

Here, in a case of removing the second cap 14, an operation of pressing the button 14A provided on the upper surface of the second cap 14 is required. Therefore, the button 14A is pressed via the pressing part 34C provided at the distal end of the pressing rod 34 (see an arrow W in FIG. 8).

Specifically, the operating part 34B provided at the upper end of the pressing rod 34 is pushed down by the operator via a finger F. As a result, the shaft 34A moves downward, and the pressing part 34C also moves downward with the movement of the shaft 34A. Then, the pressing part 34C presses the button 14A. As a result, the second cap 14 is removed from the attachment port 11.

Thereafter, the second attachment/detachment arm 32 is pulled to the retreat position while holding the second cap 14. Using the slide mechanism 40, the slide plate part 42 is moved from the second slide position to the first slide position. Then, the first attachment/detachment arm 31 that holds the first cap 12 is lowered to the attachment/detachment position to attach the first cap 12. As described above, the work of removing the second cap 14 and attaching the first cap 12 is performed.

As described above, the jig for cap replacement 100 according to the present embodiment is a jig for replacing the first cap 12 and the second cap 14 during the rotation of the zonal rotor 10. In the jig for cap replacement 100, the first attachment/detachment arm 31 is provided. The first attachment/detachment arm 31 comprises the first holding part 50 that holds the first cap 12. In addition, in the jig for cap replacement 100, the second attachment/detachment arm 32 is provided. The second attachment/detachment arm 32 comprises the second holding part 60 that holds the second cap 14. The first attachment/detachment arm 31 and the second attachment/detachment arm 32 are movable between the attachment/detachment position and the retreat position. As a result, since the cap replacement work that has been performed manually by the operator in the related art can be performed by the jig for cap replacement 100, it is possible to improve the safety of the cap replacement work.

In addition, for example, it is necessary to be proficient in the cap replacement work by hand, but since the replacement position or the operation content is predetermined by using the jig for cap replacement 100, the cap replacement work is simplified.

In addition, in the jig for cap replacement 100 according to the present embodiment, the first attachment/detachment arm 31 and the second attachment/detachment arm 32 are provided. In addition, in the jig for cap replacement 100, the slide mechanism 40 is provided. The slide mechanism 40 selectively switches the positions of the first attachment/detachment arm 31 and the second attachment/detachment arm 32 between the first slide position and the second slide position. As a result, even in a case of comprising two arms corresponding to two types of caps, the cap replacement work is further simplified. That is, in a case where there are two types of caps, since the first attachment/detachment arm 31 and the second attachment/detachment arm 32 are attached to one jig and the slide mechanism 40 that selectively switches the positions of the two arms is provided, it is not necessary to replace the entire jig, as compared with a case of replacing a jig comprising an arm for holding the first cap 12 and a jig comprising an arm for holding the second cap 14, and the workability is improved.

In addition, in the jig for cap replacement 100 according to the present embodiment, the first cap 12 and the second cap 14 are used. The first cap 12 has the connection ports 12A and 12B and is a cap for injecting or discharging a solution in a state of being attached to the zonal rotor 10. In addition, the second cap 14 is a cap that is used at a high speed (for example, 30,000 rpm) and has higher liquid tightness than the first cap 12. These caps have different attachment and detachment procedures and shapes. Therefore, by comprising an arm corresponding to each cap, the replacement work can be performed more easily.

In addition, in the jig for cap replacement 100 according to the present embodiment, the first holding part 50 of the first attachment/detachment arm 31 includes the claws 52, 54, and 56. The claws 52, 54, and 56 are claws for holding the first cap 12 and abut the first cap 12 radially. In addition, the second holding part 60 of the second attachment/detachment arm 32 includes the claws 62, 64, and 66. The claws 62, 64, and 66 are claws for holding the second cap 14 and abut the second cap 14 radially. As a result, since the first cap 12 and the second cap 14 are held by the plurality of claws, the holding force is secured, and the first cap 12 and the second cap 14 are prevented from falling off. In addition, fine operations such as rotating the first cap 12 in the held state can also be performed.

In addition, in the jig for cap replacement 100 according to the present embodiment, the claws 52, 54, and 56 are provided in the first attachment/detachment arm 31, and the claws 62, 64, and 66 are provided in the second attachment/detachment arm 32. Since the number of claws provided in each arm is three, the holding force is secured and the degree of freedom of the holding state (the degree to which an operation of holding even in a case where the claw is deviated from a position of the cap in a top view can be allowed) is secured. In a case where the number of claws is three, the holding force is secured and the holding is stabilized because the three-point support is provided, as compared with a case of two claws. In addition, in a case where the number of claws is three, the holding force is not too strong as compared with a case of four claws, and since the three-point support is provided, the holding is realized even in a state where the claw is deviated from the cap because the number of contact points is small.

In addition, in the jig for cap replacement 100 according to the present embodiment, portions of the claws 52, 54, and 56 of the first attachment/detachment arm 31 that abut the first cap 12 are formed of a hard resin. In addition, portions of the claws 62, 64, and 66 of the second attachment/detachment arm 32 that abut the second cap 14 are formed of a hard resin. Here, since the cap is made of metal, the cap is prevented from being damaged as long as the hard resin has a hardness smaller than that of the metal in general. In addition, in a case of a soft resin such as rubber, it is considered that a part of the soft resin is peeled off from the contact portion in a case of being in contact with the rotating body, and foreign matter is mixed into the centrifuge. Since the hard resin has a higher strength than rubber, the occurrence of foreign matter due to partial peeling is suppressed.

In addition, in the jig for cap replacement 100 according to the present embodiment, the air cylinder 58A is provided in the holding part body 58 of the first attachment/detachment arm 31. The air cylinder 58A moves the claws 52, 54, and 56. In addition, the same air cylinder as the air cylinder 58A is provided in the holding part body 68 of the second attachment/detachment arm 32. The air cylinder 58A also functions as a damper by the volume change of the compressed air A in the cylinder body 58B. As a result, the reaction force received from the claws 52, 54, and 56 that abut the rotating first cap 12 can be absorbed. In addition, since the air cylinder 58A is driven by the compressed air A, the holding force is stabilized without a difference in grip strength or a difference in skill level as compared with a case of manually gripping the cap.

In addition, in the jig for cap replacement 100 according to the present embodiment, the first attachment/detachment arm 31 is capable of performing an operation of rotating the first cap 12 in a state where the first holding part 50 holds the first cap 12. A disk-shaped handle 31B for moving the first attachment/detachment arm 31 between the retreat position and the holding position and for rotating the first cap 12 is provided in the first attachment/detachment arm 31. In the attachment and detachment operation of the first cap 12, an operation of rotating the first cap 12 may be required. In the present configuration, the disk-shaped handle 31B is provided in the first attachment/detachment arm 31. In a case of moving the first attachment/detachment arm 31, the handle 31B may be gripped and pushed or pulled, and in a case of an operation of rotating, the handle 31B may be rotated in the circumferential direction. As a result, the operation of moving the first cap 12 between the retreat position and the holding position and the operation of rotating the first cap 12 can be realized by one handle 31B.

In addition, in the jig for cap replacement 100 according to the present embodiment, the second attachment/detachment arm 32 includes a pressing rod 34 that is a rod-shaped member provided along a longitudinal direction of the second attachment/detachment arm 32. The pressing part 34C is provided at a lower end of the pressing rod 34. The pressing part 34C presses the button 14A provided on the second cap 14 along the movement in the longitudinal direction. In the attachment and detachment operation (for example, an operation of removing) of the second cap 14, an operation of pressing the button 14A may be required. In the present configuration, after the second cap 14 is set to the zonal rotor 10 by the second attachment/detachment arm 32, the button 14A of the second cap 14 is pressed by operating the pressing rod 34. As a result, the operation of pressing the button 14A of the second cap 14 is realized by a simple configuration. For example, the configuration is simplified as compared with a case of providing a drive mechanism for pressing the button 14A of the second cap 14.

In addition, in the jig for cap replacement 100 according to the present embodiment, the slide mechanism 40 is provided. The slide mechanism 40 comprises the slide plate part 42 and the guide rails 44A and 44B. The first attachment/detachment arm 31 and the second attachment/detachment arm 32 are inserted into the slide plate part 42. The slide plate part 42 is slidable in the first slide position and the second slide position along the guide rails 44A and 44B. The slide movement selectively switches the positions of the first attachment/detachment arm 31 and the second attachment/detachment arm 32. As a result, since the selective switching of the positions of the first attachment/detachment arm 31 and the second attachment/detachment arm 32 can be performed by one operation, the switching operation is simplified. For example, in a case of a mechanism in which the first attachment/detachment arm 31 and the second attachment/detachment arm 32 move independently, it is necessary to move each of the first attachment/detachment arm 31 and the second attachment/detachment arm 32 separately, but in the present configuration, the switching can be performed by one slide operation.

In addition, in the jig for cap replacement 100 according to the present embodiment, the slide restriction part 48 that restricts the slide movement of the slide plate part 42 is provided. The slide restriction part 48 restricts the slide movement in a state where the slide plate part 42 is held at the first slide position or the second slide position. As a result, the attachment and detachment operation of the cap is simplified. That is, the slide plate part 42 is prevented from moving during the operation of the arm.

For example, the operation of the arm includes not only the up-down movement of the arm but also the rotation of the cap, the operation of pressing the button of the cap, and the like. Therefore, it is considered that a force in an unintended direction acts on the slide plate part 42 via the arm, causing the slide movement. In the present configuration, since the slide movement can be restricted in a state where the slide plate part 42 is held at the first slide position or the second slide position, the attachment and detachment operation of the cap is simplified.

In addition, in the jig for cap replacement 100 according to the present embodiment, the first attachment/detachment arm 31 includes the shaft 31A. The shaft 31A is inserted into the slide plate part 42. In addition, the second attachment/detachment arm 32 includes the shaft 32A, and the shaft 32A is inserted into the slide plate part 42. The first attachment/detachment arm 31 and the second attachment/detachment arm 32 are moved with respect to the slide plate part 42 via the shafts 31A and 32A, respectively, to be movable in the up-down direction between the attachment/detachment position and the retreat position. As a result, the movement trajectory of the arm is stabilized, and the arm is prevented from interfering with other members of the jig for cap replacement 100.

In addition, in the jig for cap replacement 100 according to the present embodiment, the first attachment/detachment arm 31 is fixable to the slide plate part 42 via the magnetized member of the arm fixing part 46 at the retreat position. In addition, the second attachment/detachment arm 32 is also fixable to the slide plate part 42. As a result, it is prevented that the attachment/detachment arm that is not in use is inadvertently moved to the holding position or interferes with other members of the jig for cap replacement 100.

In addition, in the jig for cap replacement 100 according to the present embodiment, the positioning pins 24B and 24C are provided on the lower plate part 24. The positioning pins 24B and 24C are attached to the brackets 17A and 17B provided on the opening edge 16 of the space in which the zonal rotor 10 of the centrifuge is accommodated. As a result, the jig for cap replacement 100 is attached to the centrifuge and is positioned with respect to the opening of the space in which the zonal rotor 10 is accommodated. As a result, the burden of the work of adjusting the positions of the jig for cap replacement 100 and the zonal rotor 10 is reduced each time the jig for cap replacement 100 is attached.

The work of attaching the jig for cap replacement 100 to the centrifuge may be performed by the operator, but an attachment device comprising a lifting mechanism or a movement mechanism such as a lifting mechanism and a rotation mechanism, and a control device may be installed to automate the attachment and detachment work. The control device in the attachment device is configured to include, for example, a processor, a memory, and a storage. In this case, the control program stored in the storage is executed on the memory, so that the processor functions as the control device that controls the operation of the movement mechanism. The burden on the operator can be reduced by the automation. As the lifting mechanism or the rotation mechanism, for example, an electric actuator such as an electric cylinder can be applied. For example, as the movement mechanism, a single-axis linear actuator may be provided as a lifting mechanism, and the jig for cap replacement 100 may be capable of being lifted and lowered in the up-down direction between a standby position above the centrifuge and an attachment position to the centrifuge, and the movement mechanism may be controlled by the control device to automatically attach the jig for cap replacement 100 to the centrifuge. Alternatively, as the movement mechanism, a two-axis actuator that allows the jig for cap replacement 100 to be lifted and lowered in the up-down direction and to be moved in the horizontal direction may be provided, and the movement mechanism may be controlled by the control device to automatically attach the jig for cap replacement 100 to the centrifuge. In a case where the two-axis actuator is provided, the jig for cap replacement 100 is held at the retreat position that is separated from the space above the centrifuge in the horizontal direction at a time other than the time of the cap replacement, is moved above the centrifuge at the time of the cap replacement, and is then lowered to be attached to the centrifuge. Then, after the cap replacement, the jig for cap replacement 100 can be raised above the centrifuge and then moved to the retreat position. As described above, in a case where the two-axis actuator is provided, the space above the centrifuge can be left empty at a time other than the time of the cap replacement. In addition, a movement mechanism in which a single-axis linear actuator that moves in the up-down direction and a rotation mechanism that rotates the arm may be provided instead of the two-axis actuator.

In the above-described embodiment, the description has been made by using an example in which the first attachment/detachment arm 31 and the second attachment/detachment arm 32 are provided in the jig for cap replacement 100, but the present disclosed technology is not limited thereto. In the jig for cap replacement 100, any one of the first attachment/detachment arm 31 or the second attachment/detachment arm 32 may be provided. In this case, for example, the jig for cap replacement including the first attachment/detachment arm 31 and the jig for cap replacement including the second attachment/detachment arm 32 are used in a replaceable manner according to the cap that is a target of the attachment or the detachment.

In addition, in the above-described embodiment, the description has been made by using an example in which the first attachment/detachment arm 31 and the second attachment/detachment arm 32 are selectively switched by the slide mechanism 40, but the present disclosed technology is not limited thereto. For example, the first attachment/detachment arm 31 and the second attachment/detachment arm 32 may be selectively switched by sliding movement via separate slide mechanisms. In addition, the first attachment/detachment arm 31 and the second attachment/detachment arm 32 may be switched by a rotary switching mechanism. Specifically, the first attachment/detachment arm 31 and the second attachment/detachment arm 32 may be inserted into a common plate-shaped member, and the plate-shaped member may be rotated by 180 degrees about an intermediate position of the two arms to switch the arms.

In addition, in the above-described embodiment, the description has been made by using an example in which the slide mechanism 40 functions as the arm moving mechanism and also functions as the arm switching mechanism, but the present disclosed technology is not limited thereto. The arm moving mechanism and the arm switching mechanism may be mounted on the jig for cap replacement 100 as separate mechanisms. For example, an aspect may be adopted in which the arm itself is attachably and detachably attached to the upper plate part 22, the arm moves with respect to the upper plate part 22 to function as the arm moving mechanism, and the arm itself is replaced to function as the arm switching mechanism.

In addition, in the above-described embodiment, the description has been made by using an example in which the drive mechanism is the air cylinder, but the present disclosed technology is not limited thereto. For example, a mechanism having a motor or an actuator as a drive source may be used as the drive mechanism.

In addition, in the above-described embodiment, the description has been made by using an example in which the first cap 12 and the second cap 14 are exchanged, but the jig for cap replacement 100 according to the present disclosed technology can also be applied in a case where three or more caps are exchanged.

In addition, in the above-described embodiment, the description has been made by using an example in which the number of claws of the holding parts 50 and 60 is three, but the present disclosed technology is not limited thereto. The number of claws may be two or four or more. However, as described above, from the viewpoint of achieving both the securing of the holding force and the securing of the degree of freedom of the holding state, it is desirable that the number of claws is three.

In addition, in the above-described embodiment, the description has been made by using an example in which the holding parts 50 and 60 hold the cap by the claws, but the present disclosed technology is not limited thereto. The holding parts 50 and 60 may hold the cap with a holding force that is attachable and detachable to the zonal rotor 10, and for example, an aspect may be adopted in which the cap is held by adsorption or magnetic adsorption using air pressure.

In addition, in the above-described embodiment, the description has been made by using an example in which the jig for cap replacement 100 is operated by the operator, but the present disclosed technology is not limited thereto. The jig for cap replacement 100 may be driven by a drive mechanism that operates under the control of the control device. The control device is configured to include, for example, a processor, a memory, and a storage. In this case, the control program stored in the storage is executed on the memory, so that the processor functions as the control device that controls the operation of the drive mechanism. Then, in a case where the operator inputs an instruction to start the cap replacement work to the control device, the control device outputs an operation signal to the drive mechanism that drives each part of the jig for cap replacement 100. For example, the up-down movement of the first attachment/detachment arm 31 and the second attachment/detachment arm 32, the slide movement of the slide plate part 42, the holding operation of the cap by the holding parts 50 and 60, and the like are realized by the operation of the drive mechanism. As a result, the cap replacement work by the jig for cap replacement 100 is realized without the operation of each part by hand.

It is preferable that, in a case of automating the jig for cap replacement 100, it is configured to check whether or not a normal operation is performed for each operation of the up-down movement of the first attachment/detachment arm 31 and the second attachment/detachment arm 32 by driving each drive mechanism, the slide movement of the slide plate part 42, the holding operation of the cap by the holding parts 50 and 60, and the like, and then transition to the next operation. The drive mechanism is moved to an appropriate position, and the holding operation and the like are set in advance and are driven by the control device based on the setting. However, a slight deviation may occur in each operation. The slight deviation does not have a large influence on one cap replacement work, but may cause a failure by repeating the deviation, which may load the components around the axis of the zonal rotor 10. In order to prevent the cap replacement work from being performed in a state where such a deviation occurs, it is desirable to provide an operation monitoring sensor for checking whether or not each operation is normal in the automation. In particular, since the components around the axis of the zonal rotor 10 are delicate, it is preferable to perform the positioning of the first attachment/detachment arm 31 or the second attachment/detachment arm 32 during the removal and the attachment of the cap with high accuracy so that the components around the axis are not loaded, and it is important to check whether or not the axial deviation occurs during the holding of the cap.

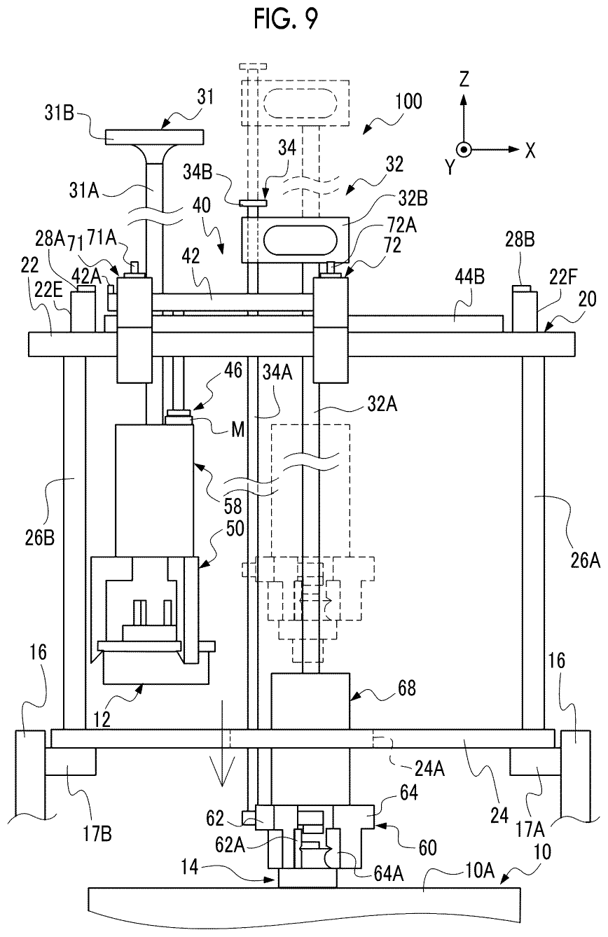

Examples of the operation monitoring sensor include a sensor that detects a positioning state in a case of selectively switching the positions of the first attachment/detachment arm 31 and the second attachment/detachment arm 32 between the first slide position and the second slide position. For example, as shown in FIG. 9, a configuration may be adopted in which protrusions 22E and 22F are provided between the holding parts 22B and 22C and the long hole 22A at both ends of the upper plate part 22 in the longitudinal direction to which the slide plate part 42 is attached, and the proximity sensors 28A and 28B are provided in the protrusions 22E and 22F. The protrusions 22E and 22F are slide stops that stop the slide plate part 40 so that the slide plate part 40 does not protrude from the right and left end parts in a case where the slide plate part 40 slides left and right. As shown in FIG. 9, a protrusion 42A for end detection is provided at an end part of the slide plate part 40, and the proximity sensor 28A detects whether or not a surface of the protrusion 42A is at a preset position. For example, the control device drives the slide mechanism 40 and slides the slide plate part 42 from the first slide position to the second slide position, and then detects whether or not the surface of the protrusion 42A is at a predetermined position in a case where the second attachment/detachment arm 32 faces the attachment port 11 of the zonal rotor 10 by the proximity sensor 28A. The control device receives the detection result from the proximity sensor, and in a case where the positioning is accurate, performs a restriction operation of restricting the movement of the second attachment/detachment arm 31, and in a case where the positioning deviation occurs, emits an alarm to notify the operator of the error. In a case where the slide plate part 42 is slid from the second slide position to the first slide position, a surface of a protrusion (not shown) provided at the opposite end part may be detected by the proximity sensor 28B.

Further, examples of the operation monitoring sensor include a sensor that detects whether or not the positioning during the up-down movement of the first attachment/detachment arm 31 or the second attachment/detachment arm 32 is accurate, particularly whether or not the positioning is accurate at the attachment/detachment position, a sensor that detects whether or not the first attachment/detachment arm 31 or the second attachment/detachment arm 32 holds the cap without deviation, and a sensor that detects whether or not the first cap 12 is rotated by the handle 31B by an accurate rotation amount. As the sensor, the above-described proximity sensor, the position detection sensor, the rotation sensor, and the like may be appropriately used. In addition, a camera that captures an image of the state of each member may be provided as the sensor, and the image analysis may be performed to detect the positioning deviation or the like.

In addition, in the above-described embodiment, the description has been made by using an example in which both the first attachment/detachment arm 31 and the second attachment/detachment arm 32 are held at the retreat position by the arm fixing part, but the present disclosed technology is not limited thereto. For example, an aspect may be adopted in which any one of the first attachment/detachment arm 31 or the second attachment/detachment arm 32 is held at the retreat position by the arm fixing part.

In addition, in the above-described embodiment, the description has been made by using an example in which the arm is fixed to the slide plate part 42 via the magnetic adsorption force in the arm fixing part 46, but the present disclosed technology is not limited thereto. For example, the arm may be held at the retreat position by a mechanical mechanism. For example, an aspect may be adopted in which the arm is always biased upward by a biasing force from a spring member or the like. In addition, for example, an aspect may be adopted in which a plunger is provided as the arm fixing part 46, and the arm is fixed to the slide plate part 42 or the like via the plunger. In addition, an aspect may be adopted in which the arm is held at the slide plate part 42 or the like by operating a holding mechanism (for example, the claw) by driving an air cylinder provided separately on the arm as a drive source.

The above-described contents and the above-shown contents are detailed descriptions for parts according to the technology of the present disclosure, and are merely examples of the present disclosed technology. For example, description related to the above configurations, functions, actions, and effects is description related to examples of configurations, functions, actions, and effects of the parts according to the present disclosed technology. Thus, unnecessary parts may be removed, new elements may be added, or the parts may be replaced with each other in the content of description and the content of illustration shown above without departing from the gist of the present disclosed technology. In order to avoid complication and easily understand the parts relating to the present disclosed technology, in the content of the above description and the content of the drawings, the description regarding common general technical knowledge which is not necessarily particularly described in terms of embodying the present disclosed technology is omitted.

The disclosure of Japanese Patent Application No. 2023-151413 filed on Sep. 19, 2023 is incorporated in the present specification by reference. All documents, patent applications, and technical standards mentioned in the present specification are incorporated herein by reference to the same extent as in a case in which each document, each patent application, and each technical standard are specifically and individually described by being incorporated by reference.

In regard to the above-described embodiment, following supplementary notes are further disclosed.

### Supplementary Note 1

A jig for cap replacement that is used in a centrifuge that centrifugally separates a sample by rotating a zonal rotor that accommodates a solution containing the sample and a density gradient medium, the jig for cap replacement being configured to replace a cap attachable to and detachable from an attachment port of the zonal rotor during rotation of the zonal rotor, the jig for cap replacement comprising:
an attachment/detachment arm including a holding part configured to hold the cap; and
an arm moving mechanism that moves the attachment/detachment arm between an attachment/detachment position at which the cap is attached and detached and a retreat position at which the attachment/detachment arm retreats from the attachment/detachment position.

### Supplementary Note 2

The jig for cap replacement according to Supplementary note 1,
wherein the cap includes two types of caps including a first cap and a second cap, the attachment/detachment arm includes a first attachment/detachment arm for attaching and detaching the first cap and a second attachment/detachment arm for attaching and detaching the second cap, and
the jig for cap replacement further comprises an arm switching mechanism that selectively switches positions of the first attachment/detachment arm and the second attachment/detachment arm between a first position at which the first attachment/detachment arm faces the attachment port and a second position at which the second attachment/detachment arm faces the attachment port.

### Supplementary Note 3

The jig for cap replacement according to Supplementary note 2,
wherein the first cap is a cap that has a connection port to which a pipe for injecting or discharging the solution is connected and is used in a case where the solution is injected into or discharged from the zonal rotor in a state where the first cap is attached to the attachment port, and
the second cap is a cap that has higher liquid tightness than the first cap and is used in a case where the zonal rotor is rotated at a second rotation speed higher than a first rotation speed used in a case where the solution is injected or discharged.

### Supplementary Note 4

The jig for cap replacement according to Supplementary note 2 or 3,
wherein the holding part of the first attachment/detachment arm includes a plurality of first claws that are claws for holding the first cap and that abut the first cap in a radial direction, and
the holding part of the second attachment/detachment arm includes a plurality of second claws that are claws for holding the second cap and that abut the second cap in a radial direction.

### Supplementary Note 5

The jig for cap replacement according to Supplementary note 4,
wherein the first attachment/detachment arm includes two or more first claws, and the second attachment/detachment arm includes two or more second claws.

### Supplementary Note 6

The jig for cap replacement according to Supplementary note 4 or 5,
wherein portions of the first claws and the second claws that abut the first cap and the second cap are formed of a hard resin.

### Supplementary Note 7

The jig for cap replacement according to any one of Supplementary notes 4 to 6,
wherein the first attachment/detachment arm includes a first air cylinder that moves the plurality of first claws with respect to the first cap, and
the second attachment/detachment arm includes a second air cylinder that moves the plurality of second claws with respect to the second cap.

### Supplementary Note 8

The jig for cap replacement according to any one of Supplementary notes 2 to 7,
wherein the first attachment/detachment arm is capable of performing an operation of rotating the first cap in a state where the holding part holds the first cap.

### Supplementary Note 9

The jig for cap replacement according to any one of Supplementary notes 2 to 8,
wherein the second attachment/detachment arm includes a pressing rod that is a rod-shaped member provided along a longitudinal direction of the second attachment/detachment arm, and
the pressing rod includes a pressing part that presses a button provided on the second cap along a movement of the pressing rod in the longitudinal direction.

### Supplementary Note 10

The jig for cap replacement according to any one of Supplementary notes 2 to 9,
wherein the arm switching mechanism includes a slide plate part that is a plate-shaped member into which the first attachment/detachment arm and the second attachment/detachment arm are inserted, and a guide rail that guides a slide movement of the slide plate part, and
the slide plate part slides between the first position and the second position along the guide rail to selectively switch the positions of the first attachment/detachment arm and the second attachment/detachment arm.

### Supplementary Note 11

The jig for cap replacement according to Supplementary note 10,
wherein the arm switching mechanism further includes a restriction part that restricts the slide movement of the slide plate part in a state where the slide plate part is held at the first position or the second position.

### Supplementary Note 12

The jig for cap replacement according to any one of Supplementary notes 1 to 11,
wherein the attachment/detachment arm includes a shaft that is a rod-shaped member in which the holding part is provided at one end,
the arm moving mechanism includes an arm support part that is a plate-shaped member into which the shaft of the attachment/detachment arm is inserted, and
the attachment/detachment arm is moved between the attachment/detachment position and the retreat position by causing the attachment/detachment arm to move via the shaft with respect to the arm support part.

### Supplementary Note 13

The jig for cap replacement according to Supplementary note 12,
wherein the attachment/detachment arm is fixable to the arm support part at the retreat position.

### Supplementary Note 14

The jig for cap replacement according to any one of Supplementary notes 1 to 13, further comprising:
an attachment part for positioning the jig for cap replacement at a predetermined position with respect to the zonal rotor and for attaching the jig for cap replacement to an opening of a space in which the zonal rotor is accommodated in the centrifuge.

What is claimed is:

1. A jig for cap replacement that is used in a centrifuge that centrifugally separates a sample by rotating a zonal rotor that accommodates a solution containing the sample and a density gradient medium, the jig for cap replacement being configured to replace a cap attachable to and detachable from an attachment port of the zonal rotor during rotation of the zonal rotor, the jig for cap replacement comprising:
an attachment/detachment arm including a holding part configured to hold the cap; and
an arm moving mechanism that moves the attachment/detachment arm between an attachment/detachment position at which the cap is attached and detached and a retreat position at which the attachment/detachment arm retreats from the attachment/detachment position.

2. The jig for cap replacement according to claim 1,
wherein the cap includes two types of caps including a first cap and a second cap,
the attachment/detachment arm includes a first attachment/detachment arm for attaching and detaching the first cap and a second attachment/detachment arm for attaching and detaching the second cap, and
the jig for cap replacement further comprises an arm switching mechanism that selectively switches positions of the first attachment/detachment arm and the second attachment/detachment arm between a first position at which the first attachment/detachment arm faces the attachment port and a second position at which the second attachment/detachment arm faces the attachment port.

3. The jig for cap replacement according to claim 2,
wherein the first cap is a cap that has a connection port to which a pipe for injecting or discharging the solution is connected and is used in a case where the solution is injected into or discharged from the zonal rotor in a state where the first cap is attached to the attachment port, and
the second cap is a cap that has higher liquid tightness than the first cap and is used in a case where the zonal rotor is rotated at a second rotation speed higher than a first rotation speed used in a case where the solution is injected or discharged.

4. The jig for cap replacement according to claim 2,
wherein the holding part of the first attachment/detachment arm includes a plurality of first claws that are claws for holding the first cap and that abut the first cap in a radial direction, and
the holding part of the second attachment/detachment arm includes a plurality of second claws that are claws for holding the second cap and that abut the second cap in a radial direction.

5. The jig for cap replacement according to claim 4,
wherein the first attachment/detachment arm includes two or more first claws, and the second attachment/detachment arm includes two or more second claws.

6. The jig for cap replacement according to claim 4,
wherein portions of the first claws and the second claws that abut the first cap and the second cap are formed of a hard resin.

7. The jig for cap replacement according to claim 4,
wherein the first attachment/detachment arm includes a first air cylinder that moves the plurality of first claws with respect to the first cap, and
the second attachment/detachment arm includes a second air cylinder that moves the plurality of second claws with respect to the second cap.

8. The jig for cap replacement according to claim 2,
wherein the first attachment/detachment arm is capable of performing an operation of rotating the first cap in a state where the holding part holds the first cap.

9. The jig for cap replacement according to claim 2,
wherein the second attachment/detachment arm includes a pressing rod that is a rod-shaped member provided along a longitudinal direction of the second attachment/detachment arm, and
the pressing rod includes a pressing part that presses a button provided on the second cap along a movement of the pressing rod in the longitudinal direction.

10. The jig for cap replacement according to claim 2,
wherein the arm switching mechanism includes a slide plate part that is a plate-shaped member into which the first attachment/detachment arm and the second attachment/detachment arm are inserted, and a guide rail that guides a slide movement of the slide plate part, and
the slide plate part slides between the first position and the second position along the guide rail to selectively switch the positions of the first attachment/detachment arm and the second attachment/detachment arm.

11. The jig for cap replacement according to claim 10,
wherein the arm switching mechanism further includes a restriction part that restricts the slide movement of the slide plate part in a state where the slide plate part is held at the first position or the second position.

12. The jig for cap replacement according to claim 1,
wherein the attachment/detachment arm includes a shaft that is a rod-shaped member in which the holding part is provided at one end,
the arm moving mechanism includes an arm support part that is a plate-shaped member into which the shaft of the attachment/detachment arm is inserted, and
the attachment/detachment arm is moved between the attachment/detachment position and the retreat position by causing the attachment/detachment arm to move via the shaft with respect to the arm support part.

13. The jig for cap replacement according to claim 12,
wherein the attachment/detachment arm is fixable to the arm support part at the retreat position.

14. The jig for cap replacement according to claim 1, further comprising:
an attachment part for positioning the jig for cap replacement at a predetermined position with respect to the zonal rotor and for attaching the jig for cap replacement to an opening of a space in which the zonal rotor is accommodated in the centrifuge.

15. A jig for cap replacement that is for replacing a cap attachable to and detachable from an attachment port of a zonal rotor, the jig for cap replacement comprising:
an attachment/detachment arm including a holding part that holds the cap; and
an arm moving mechanism that moves the attachment/detachment arm between an attachment/detachment position at which the cap is attached and detached and a retreat position at which the attachment/detachment arm retreats from the attachment/detachment position.
